(19) United States
(12) Patent Application Publication
(10) Pub. No.: US 2021/0279606 A1
(43) Pub. Date: Sep. 9, 2021

(54) AUTOMATIC DETECTION AND ASSOCIATION OF NEW ATTRIBUTES WITH ENTITIES IN KNOWLEDGE BASES

(71) Applicant: Samsung Electronics Co., Ltd., Suwon Si (KR)

(72) Inventors: Vijay Srinivasan, Mountain View, CA (US); Christian Koehler, Mountain View, CA (US); Hongxia Jin, Mountain View, CA (US)

(21) Appl. No.: 16/813,510

(22) Filed: Mar. 9, 2020

(51) Int. Cl. G06N 5/04; G06N 20/00

(52) U.S. Cl. CPC G06N 5/04; G06N 20/00

(57) ABSTRACT

Systems and methods are described for adding new attributes to entities of a knowledge base. A plurality of correlations may be identified between the new attribute and existing attributes of the entities using a rule-based model, such that attribute rules may be associated with each identified correlation exceeding a predetermined confidence threshold. An unstructured data model may then be applied to the knowledge base to identify unstructured data associated with each entity of the plurality of entities correlated to presence of the new attribute. Then a meta learner model may be applied to identify weights for each attribute rule and the identified unstructured data. After the weights have been set for the meta learner model, the meta learner model may then be applied to each entity in the knowledge base to accurately identify entities having the new attribute.

### TECHNICAL FIELD

The present disclosure generally relates to managing knowledge bases, and in particular to the determination of new attributes not present in an existing knowledge base.

### BACKGROUND

Organizations spend significant resources to construct a knowledge base or database about a particular domain of knowledge, such as movies, products, recipes, and wine. Each knowledge base may include a vast number of entities, each organizing data in a variety of fields. These knowledge bases or databases are used in several applications: question answering, displaying information on apps/web pages, search, recommendations, etc. An entity is a node in the knowledge graph representing a thing, such as a movie or a person in a movie knowledge base. Each entity, such as a movie, may have several attributes, such as rating, warnings, advisories, or awards. For a given domain, once a knowledge base or database covering millions of entities (say products or movies) is created, it is challenging to provide information about new attributes that are not explicitly present in the database. If there is no explicit information in the database to indicate if entities have the new attribute of interest, it must be identified and manually added to every relevant entity in the database, using conventional techniques.

### SUMMARY

Systems and methods are described for determining new attributes to existing knowledge bases. A processor of a computer having memory may retrieve a new attribute to be added to each of the plurality of entities. The processor may then mine attribute rules that determine a relationship between existing attributes, of a first plurality of entities from the knowledge base, and the new attribute. Each attribute rule may be associated with a confidence value, which may be used to determine which rules are used in a rule-based classifier.

The rule-based classifier may be trained by applying the mined attribute rules to a second plurality of entities. Application of the attribute rules may be controlled by the rule-based classifier based on a confidence value threshold, which is compared to the confidence value for each attribute rule. Then a meta learner model may be trained to apply weights to an output of the rule-based classifier. After the weights have been set for the meta learner model, the meta learner model may then be applied to identify association of the entities of the knowledge base with the new attribute.

### BRIEF DESCRIPTION OF THE DRAWINGS

In the following drawings, like reference numbers are used to refer to like elements. Although the following figures depict various examples, the one or more implementations are not limited to the examples depicted in the figures.

FIG. 1 shows a block diagram of a specific embodiment for a system for detecting a new attribute in an existing knowledge base.

FIG. 2 shows a specific embodiment of a flow diagram for a method of detecting a new attribute in an existing knowledge base.

FIG. 3 shows a block diagram of a specific embodiment of a knowledge graph entity displaying entities and triples connecting the entities.

FIG. 4 shows a block diagram of a specific embodiment for a system for training a new attribute model that detects a new attribute in an existing knowledge base.

FIG. 5 shows another specific embodiment of a flow diagram for a method of training a new attribute model that detects a new attribute in an existing knowledge base.

FIG. 6 shows a specific embodiment of a flow diagram for a method of generating training data for the various models used in detecting a new attribute in an existing knowledge base.

FIG. 7 shows a block diagram of a specific embodiment of a system for detecting a new attribute in an existing knowledge base that incorporates an additional model for entity embedding-based attribute inference.

FIG. 8 shows a specific embodiment of a flow diagram for a method of applying a text classifier to identify unstructured data correlated to presence or absence of a new attribute.

FIG. 9 a block diagram of a specific embodiment of a meta-learner model for detecting a new attribute in an existing knowledge base.

FIG. 10 depicts a block diagram illustrating an exemplary computing system for execution of the operations comprising various embodiments of the disclosure.

### DETAILED DESCRIPTION

Given an existing domain knowledge base or database for a given subject matter domain, where the domain includes multiple entities, and one or more target entity types, the described embodiments automatically infer the presence or absence of a new attribute not currently present in the database. Using the modeling approaches described herein, interpretable results may be provided for the inference of the new attribute, such that the reasons for any inference/non-inference may be transparent. The described solutions may receive an existing domain knowledge graph (“KG”) or a database and a new attribute not currently in the database/KG, where the new attribute may be applicable to all entities of a given type. The described solutions may learn an attribute model, and use the attribute model to accurately infer the presence or absence of the new attribute for all existing and future entities of the given type.

To infer the presence of the new attributes, the described solutions combine attribute rule mining on structured data with attribute classifiers based on unstructured data to infer the new attributes. The interpretability, precision, and coverage of new attribute labeling may be improved by combining attribute rules mined from structured data in the KG with distantly supervised classifiers trained on unstructured data in the KG such as text, images or videos.

In some embodiments, mined attribute rules may be used to distantly supervise attribute classifiers based on unstructured data. The precision and coverage of attribute classification based on unstructured data may be improved by using weakly-labeled training data generated by mined high confidence attribute rules for supervising classifiers based on unstructured data. Having more training data may result in a better-tuned model for classification based on unstructured data.

The quality of training data may further be improved by selecting candidate positive and negative entity examples for the new attribute based on utility and entity similarity. Crowd-sourced training label generation effort and time may be reduced by selecting candidate positive and negative entity examples to label based on multiple factors, including entity similarity and utility of new examples based on labeling uncertainty. Further optimizations in the training data may be obtained by selecting candidate users for labeling examples based on historical user labeling behavior on entities and attributes. Crowd-sourced training label generation effort and time may be further reduced by selecting candidate users based on historical user behavior in labeling the same entities or similar entities/attributes in the past.

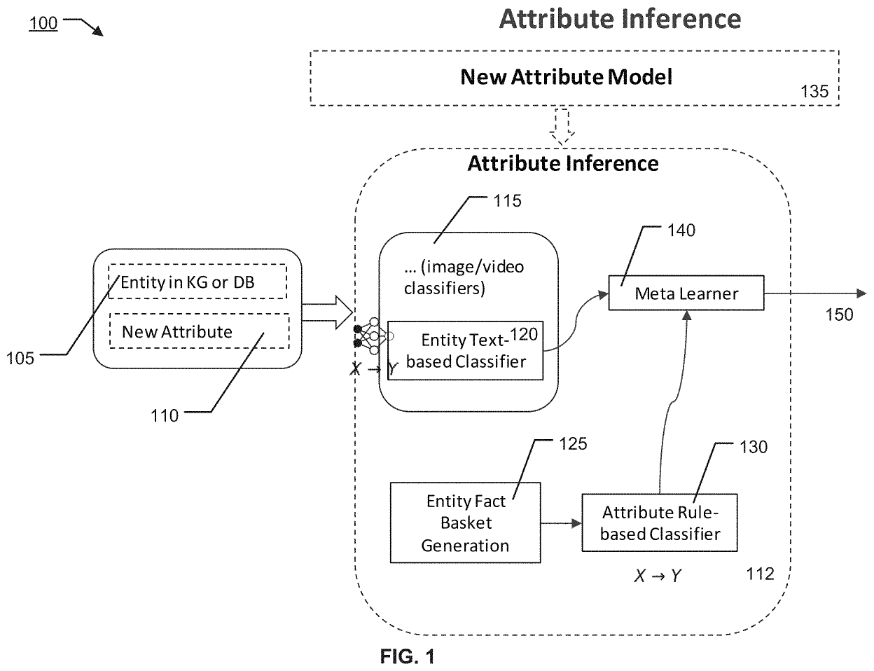

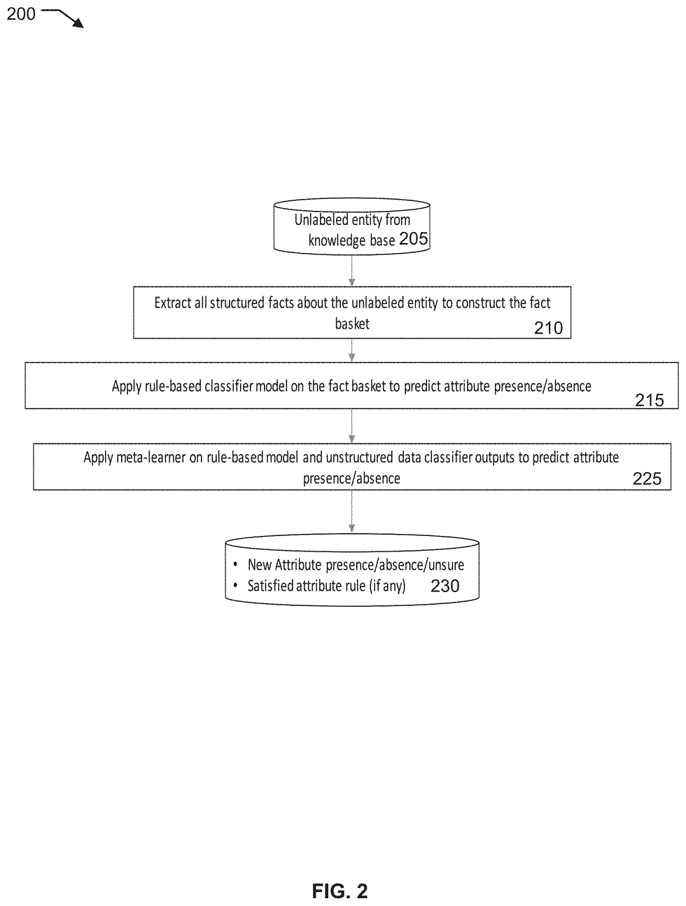

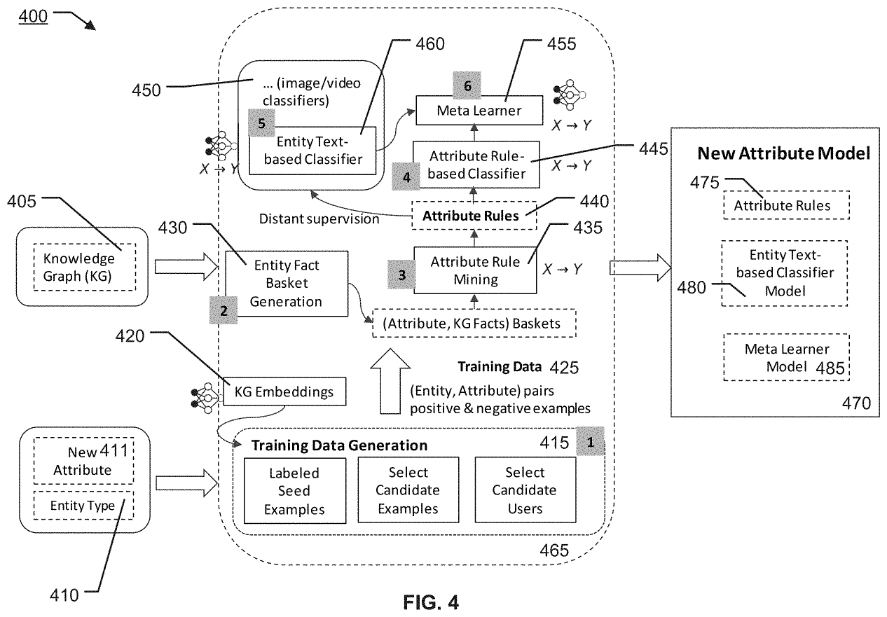

FIG. 1 shows a block diagram of a specific embodiment for a system 100 for detecting a new attribute 110 in an existing knowledge base. System 100, which may include one or more computing devices or servers, receives an unlabeled entity 105 in a knowledge graph or database and the new attribute 110, for which the classification models of new attribute model 135 have been trained. The unlabeled entity 105 may be associated with a number of existing attributes, but has not been associated with positive or negative presence of the new attribute. The system 100 may include the knowledge graph/database, or may be communicatively coupled to the system including the knowledge graph via a network connection (i.e. using a local network or a remote network, such as the Internet). The use of the classifiers by the new attribute model 135 is shown in attribute inference block 112. As shown in block 112, a fact basket 125 for the unlabeled entity 105 is generated from structured data from the knowledge graph. Each fact basket 125 may include all existing attributes associated with the unlabeled entity 105 in the knowledge graph, or a subset that is selected based on rules applied by the attribute rule-based classifier 130. The attribute rule-based classifier 130 may then be applied to the fact basket received from block 125 to make inferences on the presence or absence of the new attribute. Meanwhile, the entity text-based classifier may be applied to textual data, from the knowledge graph, associated with the unlabeled entity 105 at block 120. Optionally, other classifiers, such as an image classifier and/or a video classifier may be applied to the appropriate unstructured data associated with the unlabeled entity 105 at block 115. The results of the entity text-based classifier 120 and the attribute rule-based classifier 130 are provided to the meta learner model 140, which has been trained to apply various weights to the results to make a final determination 150 of the presence or absence of the new attribute 110 for the unlabeled entity 105. The functionality of each of the shown classifiers and models is detailed in greater detail below. FIG. 2 and the accompanying text detail the operation of system 100 during runtime, while FIG. 4 and its accompanying text describe the training of system 100 in greater detail.

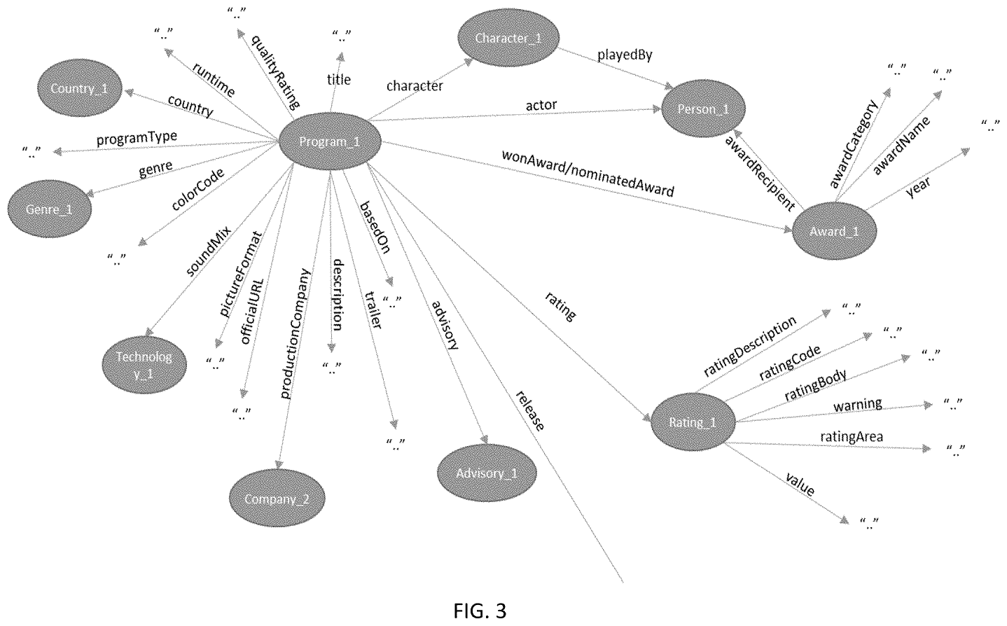

FIG. 2 shows a specific embodiment of a flow diagram for a method 200 of inferring presence or absence of a new attribute in an existing knowledge base. A processor of a computer having memory, such as a computing device in communication with the system that stores the knowledge base, may execute the new attribute model, which performs the steps of method 200. The new attribute model may receive the unlabeled entity 105 from the knowledge base as an input at block 205. As stated above, the knowledge base may be a knowledge graph that includes entities connected by triples, or a database including the information about the entities. An example of a knowledge graph may be seen in FIG. 3, which shows a block diagram of a specific embodiment of a knowledge graph 300 displaying entities and triples connecting the entities.

In knowledge graph 300, the knowledge base displayed is movies, and the entities are shown as nodes. Entities may exist for movie titles, such as entity 305, or for other features, such as awards won, as seen in entity 320. A triple, such as triple 310, may be represented as a line connecting different entities, and represents structured information or facts about the entity or entities connected to the triple. Triple 310 represents that the movie title represented by entity 305 has won the award or been nominated for the award represented by entity 320. While the triples associated with an entity represent structured data in the knowledge graph 300, unstructured data may also be associated with the various entities. For example, the knowledge graph 300 may indicate that a trailer video 325 is associated with the movie title represented by entity 305. The trailer video 325 may be a video file that requires parsing to understand what the trailer 325 says about the movie title 305. Other forms of unstructured data may be also associated with entities 305 and 320, including textual data (e.g., a description of a movie's plot, a warning associated with a particular movie rating, etc.), and/or visual data.

Returning to FIG. 2, at step 210, structured facts about the unlabeled entity are extracted from the knowledge base to construct a fact basket for the unlabeled entity. For each entity being processed by the new attribute model, a fact basket may be created that contains the presence or absence of the new attribute along with facts about the entity extracted from triples in the knowledge base. When extracting facts about the entity, more than one hop may be traversed to extract facts in some embodiments. For example, in a movie knowledge base, for unlabeled movie A, a basket from the knowledge base that includes the following facts: (genre=thriller, plotElement=junkie, has Award-Award Category=Best Cinematography, has Actor=Reese Witherspoon, has Actor-has Award-Award Category=Best Lead Actor (Female), ‘drug-use’=true). For a different movie B, a fact basket may be created that includes the following facts from the structured data in the knowledge base: (genre=a nimation, plotElement=fairyTale, ‘drug-use’=false, genre=Children).

The fact baskets accrue structured data associated with an entity, so different facts may be compared to stored rules at step 215 to determine presence or absence of the new attribute. The comparison may be performed using a trained rule-based classifier model, which applies rules mined in training to infer presence or absence of the new attribute. Such rules may be limited to high precision rules at the cost of low coverage, since providing a wrong answer to the user may be more undesirable at the structured data analysis phase. Accordingly, both positive rules and negative rules, having high confidence and lift factor, may be applied to the fact basket to determine if any of the rules are satisfied. For a given entity, if at least one high confidence positive rule is present and no high confidence negative rules are present, the unlabeled entity may be labeled as having the new attribute present. Similarly, an entity may be labeled with attribute absence if at least one high confidence negative rule is present and no high confidence positive rules are present. In addition to inferring presence or absence of the new attribute, the rule-based model may return the relevant positive or negative rule to improve the interpretability of the determination to users and/or system administrators. Other entities, which do not satisfy the positive/negative conditions reflected by the applied rules, may be labeled as unsure, thereby not affecting the precision of rule-based model by making a less-accurate prediction.

In an optional step (not shown in FIG. 2), an unstructured data model may be applied to unstructured data associated with the unlabeled entity to identify the absence or presence of the new attribute. The unstructured data model may in some embodiments operate on entity description text (e.g., a plot description for a movie, product descriptions, etc.), and may be trained using labeled entity-attribute pairs, as is further described below. In other embodiments, different types of unstructured data may be processed by the unstructured data model, including image data and/or video data associated with the unlabeled entity (e.g., a trailer video for a movie, pictures of a product, etc.).

For embodiments where the unstructured data model performs text classification, any suitable approach, such as a bag of words text classifier or a deep learning model based on character level CNNs (Convolutional Neural Networks) that depend on the number of training examples available, for example, may be used. For example, for an entity named movie Y in a movie knowledge base, the rule-based model may apply a high-confidence rule, where (genre=crime, plotElement=gang)->‘drug-use. The output of the rule-based model may not be very conclusive; for example, the accompanying data for the unlabeled movie Y may be (confidence=63%, support=80 movies, lift factor=8). Such data may result in movie Y being labeled “unsure” by the rule-based model. However, the unstructured data model may include a text classifier that identifies drug use with high prediction probability (e.g., a probability of 1) based on the overview of the plot of movie Y, which may read: “Friends and family of Cory, a young man who has died of an overdose, gather at a Baltimore-area karaoke bar for his wake and compare stories about him” Accordingly, the new attribute model may label movie Y as a movie with elements of ‘drug-use’ based on the overview text, therefore improve the coverage of movies that that can be labeled accurately with drug-use

In some embodiments, distant supervision may be used to increase the amount of training data available for the text classifier. The distant supervision may include using the output of the attribute rule-based classifier to generate additional high precision training examples for the text classifier, resulting in better performance for the unstructured data model.

Finally, at step 225 the prediction output from the attribute rule-based model and the unstructured data model may be combined using a weighted meta learner model. For example, the prediction outputs from the multiple classifiers may be combined using a trained meta-learner, which has been trained to learn the weights to apply to each classifier output. Block 230 describes the output of the new attribute model: an inference on whether the new attribute is present, absent, or if the conclusion is unsure for the unlabeled entity based on the meta learner model, and a display of any satisfied attribute rules for presence/absence of the new attribute. The display of the satisfied attribute rules advantageously allows for interpretability for any user, as the user may make their own conclusions on how to label the unlabeled entity based on the displayed rules.

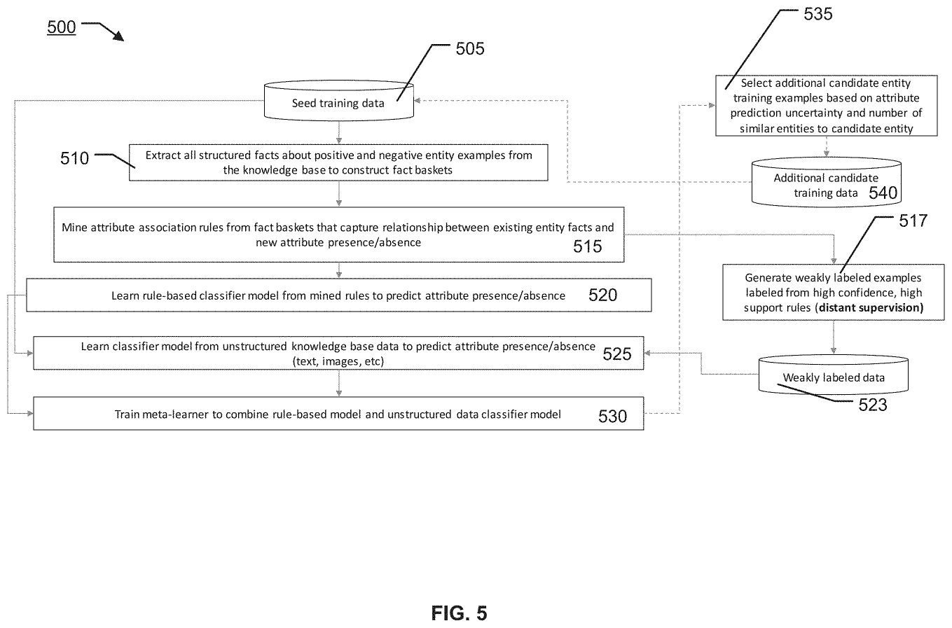

FIG. 4 shows a block diagram of a specific embodiment for a system 400 for training a new attribute model 470 that detects a new attribute in an existing knowledge base 405. FIG. 5 shows another specific embodiment of a flow diagram for a method 500 of training a new attribute model that detects a new attribute to an existing knowledge base. The training process, encapsulated in block 465, receives the knowledge base, including entities and triples, in the form of knowledge graph (KG) 405 in the embodiment shown in FIG. 4. The other inputs received include the new attribute 411 to be detected in the KG 405 and an identifier of the entity type 410 to be labeled with the new attribute 411. When the training process 465 is complete, the new attribute model 470 is ready to infer presence or absence of the new attribute 411 for all entities in KG 405 having the identified entity type 410. The new attribute model may make inferences for each unlabeled entity by applying the attribute rules 475 to a fact basket generated for the unlabeled entity using a rule-based model and applying an unstructured data model, such as an entity text-based classifier model 480, to unstructured data associated with the unlabeled entity. The results may be combined using a meta learner model 485 to output the final new attribute inference for the unlabeled entity.

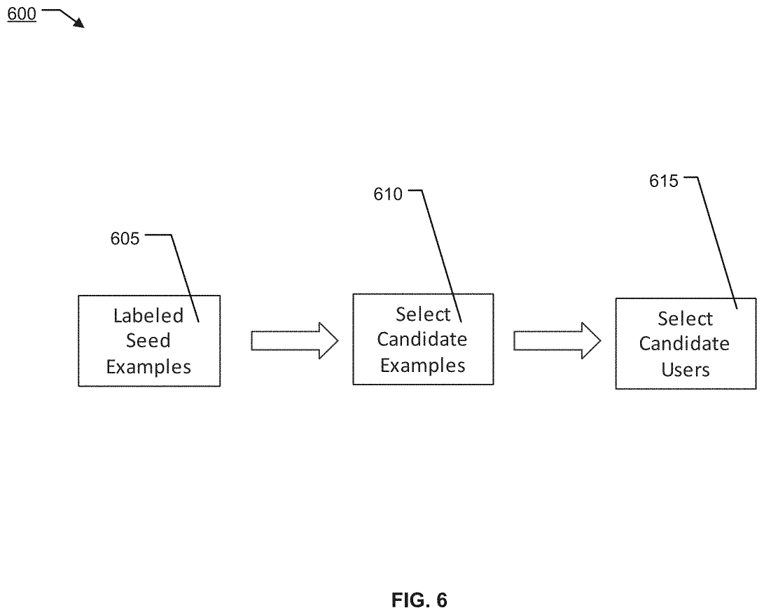

Method 500 describes the operation of the blocks within the training process 465. At block 505, the new attribute model may be seeded with training data, as is shown in block 415 of FIG. 4. The training data may be a first plurality of entities from a knowledge base that have been labeled as having the new attribute present or absent. Varying embodiments on supplementing the training data are discussed below, in the text accompanying FIG. 6.

At step 510, all structured facts about the positive and negative entity-attribute pairs 425 may be extracted from the knowledge base to construct fact baskets including the new attribute label 430 for each entity in the training data (as is done for the unlabeled entities during the inference phase described above). One difference in the training stage is that the new attribute presence or absence fact is added to the fact basket generated in step 510 in order to learn association rules that capture the relationship between existing attributes and the new attribute.

At step 515, attribute association rules may be mined from the fact baskets for the training data entities via block 435. Each association rule may be associated with a confidence value. From the association rules identified, a subset of association rules 440 having a confidence value that exceeds a predetermined threshold may be selected at step 515 for the attribute rule-based classifier model 445 to predict presence or absence of the new attribute. At step 520, the rule-based classifier model may be trained using the selected attribute association rules. In order to train the model in step 520, a separate, second plurality of entities that includes a smaller set of held-out test data having entities labeled with the presence or absence of the new attribute may be used. The test set may be different from the training data used to mine the attribute rules in step 515. The training step 520 may also include selecting a second confidence and lift factor threshold based on the held-out testing set, to maximize the accuracy of labeling entities on the testing set. At runtime, when an entity that is not labeled with the new attribute is input, the rule-based classifier 130 may determine if any positive or negative rule exceeding the second confidence and lift factor threshold is satisfied for the input unlabeled entity. If one or more positive rules are satisfied and no negative rules are satisfied, attribute presence may be output by the rule-based classifier 130. If one or more negative rules are satisfied and no positive rules are satisfied, attribute absence may be output by the rule-based classifier 130. If no rules are satisfied, or both positive and negative rules are satisfied, an unsure attribute detection may be output, as shown in block 230 in FIG. 2. In alternative embodiments, the rule-based training and classification may combine the confidence values from multiple satisfied positive and negative rules to detect attribute presence or absence.

The association rules may be based on a plurality of correlations between the presence or absence of the new attribute and the structured facts (i.e. the existing attributes) of the plurality of entities that may be identified during the training process. In an embodiment, the class association rule mining performed at step 515 may mine attribute rules of the form {pre-condition attributes}->post-condition to infer the presence (positive rule) or absence (negative rule) of the new attribute. The support measure of a set of attributes (pre-condition attributes or post-condition attributes) may be defined as the probability of observing the attributes in the set of entities in the knowledge graph (i.e., support=number of entities with the attributes divided by the total number of entities in the entire knowledge graph). Each rule may associated with a plurality of measures assessing the utility of the rules: (i) a support measure for the pre-condition attributes for each rule (which may be defined as described above), (ii) a confidence measure, which may be defined as the conditional probability of observing post-condition attributes given the set of pre-condition attributes for each rule (i.e., confidence=a number of entities with the post-condition attributes and pre-condition attributes divided by the number of entities with the pre-condition attributes), and (iii) a lift factor, which may be defined as the confidence measure of the rule divided by the probability of observing the post-condition attributes of the rule in the entire set of entities (i.e., lift factor=confidence measure of rule/support measure of the post-condition attributes of the rule). The support and confidence measures can be expressed as probabilities between 0 to 1 or as percentage values.

Some example rules for the exemplary movie knowledge base may be expressed as follows:

(plotElement=junkie)->‘drug-use’ (confidence=100%, lift factor=25) (1)

(genre=crime, plotElement=gang)->‘drug-use’ (confidence=63%,lift factor=8) (2)

(plotElement=parent child relationship, age rating=PG, genre=adventure)->‘family-friendly’(confidence=100%, lift factor=11) (3)

(plotElement=dying and death, genre=mystery, age_rating=PG-13, genre=thriller)->‘not family-friendly’(confidence=100%, lift factor=1.1) (4)

The four exemplary rules may relate to two new attributes: “drug use” and “family friendly”. Rule 1 has a confidence of 100%, meaning that every time an entity is associated with the “junkie” plot element, the “drug use” attribute is present. Rule 1 also has a lift factor of 25, indicating that the presence of the “drug use” attribute is much higher for the “junkie” related movies compared to the presence of “drug use” in the movie population as a whole. Together, the two factors would suggest that there is a strong correlation between movies with the plot element “junkie” and “drug use.” If the second confidence threshold for selecting association rules is 100% and the lift factor threshold is 10 in an exemplary embodiment of 520, then rules 1 and 3 would be selected for the rule-based model. Note that the criteria for selecting rules, where a higher confidence and lift factor are desirable, differ from the criteria for selecting training data, where selecting labeled entity-attribute pairs with high confidence would not improve the ability of the rule-based model to make an accurate inference on absence/presence of the new attribute.

By contrast with rule 1, rule 2 has a lower confidence of 63%, and a lower lift factor of 8. This means that there is significant uncertainty whether or not an entity having a genre attribute of “crime” and a plot element of “gang” is associated with the new attribute “drug use,” and that the correlation is not quite as strong as the correlation observed for rule 1. Accordingly, if the second confidence threshold determined by 520 is 100%, rule 2 indicates an unsure answer of only having potential drug use and would not be selected by 520 to make inferences in the final rule-based model. Rules 3 and 4 relate to presence and absence of the “family friendly” attribute respectively. In an embodiment where the second confidence threshold is 100% and lift factor is 10, rule 3 would be added to the rule-based model since it satisfies both the confidence and lift factor thresholds.

In some embodiments, after the association rules have been selected, a user may modify the rules to customize the behavior of the new attribute model as a whole. This may be facilitated by the interpretability of the inferences made, since the rules responsible for an inference may be displayed. For example, one of the rules for a new attribute “family friendly” in the movie knowledge base may state: (plotElement=bully, age_rating=PG)->‘family friendly.’ If a user does not want to expose their child to themes about bullies yet, they may modify the rule to predict ‘not family friendly’ (indicating absence of the new attribute, rather than presence), thereby changing the output of the new attribute model. To present a minimal non-redundant set of rules to end users, maximal association rules may be identified, or further optimizations, such as the Rule Miner algorithm, may be applied to discover a small set of summarized attribute rules that cover most of the examples in the larger set of rules.

Unstructured data from the training data entities 505 may be used to detect correlations between features of the unstructured data with absence or presence of the new attribute at step 525. This may be done, for example, at block 460 in FIG. 4 using a text-based classifier, being trained on text data received for each training entity in the training data 505. While the discussion below centers on using a text-based classifier 460 as the unstructured data model, various embodiments may supplement the text-based classifier with an image-based or video-based classifier 450. Such alternative classifiers 450 may be trained using images to identify specific features about images of products (e.g., if a woman's blouse has new attributes such as puffy sleeves), or attributes such as if a film is violent based on identifying features such as weapons in a movie poster or trailer.

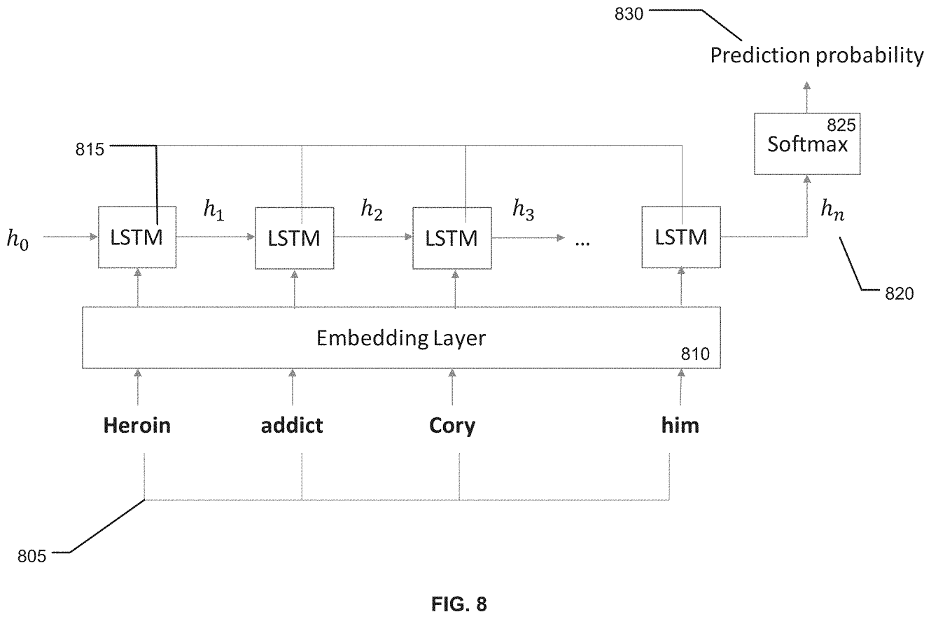

As stated above, any suitable approach, such as a standard deep learning model such as Long Short-Term Memory networks (LSTMs) may be used as the text-based classifier model 460 at step 525, which may operate on unstructured data for the unlabeled entities as shown in the example in FIG. 8. To train the text-based classifier, unstructured data associated with each entity of the second plurality of entities may analyzed, where each entity of the second plurality of entities is labeled as having the new attribute present or absent. The LSTM network 815 shown in FIG. 8 may receive a previous state value based on past words and may iterate on each input word 805 to output a prediction probability for each word between 0 and 1, where values closer to 0 indicate attribute absence, and values closer to 1 indicate attribute presence. Each input word 805 from, for example, a movie plot summary may be passed through an embedding layer 810, or pre-trained word embeddings trained on a large corpus may be used. In some embodiments, the identified words may be weighted based on the prediction probabilities for each word.

The final hidden state hₙ 820 of the LSTM network 815 may be passed through a softmax layer 825 to output the prediction probability 830 for the unstructured data for the unlabeled entity. The training may be based on the training labels (i.e., the new attribute being present or absent for the training entities) and entity description text (e.g., a plot description for movie, product descriptions, etc.), from which the LSTM may automatically identify words and text patterns that indicate attribute presence or absence through the training process. The LSTM network shown in FIG. 8 is just one example of a text classifier that may be used to detect attribute presence or absence. Other classifiers, such as a Naïve Bayes classifier based on a bag of words model, a CNN (Convolutional Neural Network) model, or a bi-LSTM (bi-directional LSTM) with attention may be used to detect attribute presence or absence and output a prediction probability from the input text. Returning to FIG. 4, The prediction probability output by the text-based classifier may then be input to the meta-learner model 455 to make a final determination on attribute presence or absence.

Furthermore, some embodiments may use distant supervision to increase the amount of training data available for the text classifier. Distant supervision may include using the output of the attribute rule-based classifier 440 to generate additional high precision training examples for the text classifier 460 during training. Returning to FIG. 5, weakly-labeled examples 523 may be obtained during training (step 515) of the rule-based model using high-confidence, and high lift factor rules, such as rule 1 discussed above, applied to the remainder of the knowledge base at step 517. Since attribute presence is only based on the identified association rules, it is deemed weak, although the confidence is high that the previously unlabeled entities do include the new attribute based on the association rules having high confidence and support measures. The weakly-labeled data 523 may then be used as an additional input to the training step 525 for the text-based classifier 460, as is shown in system 400.

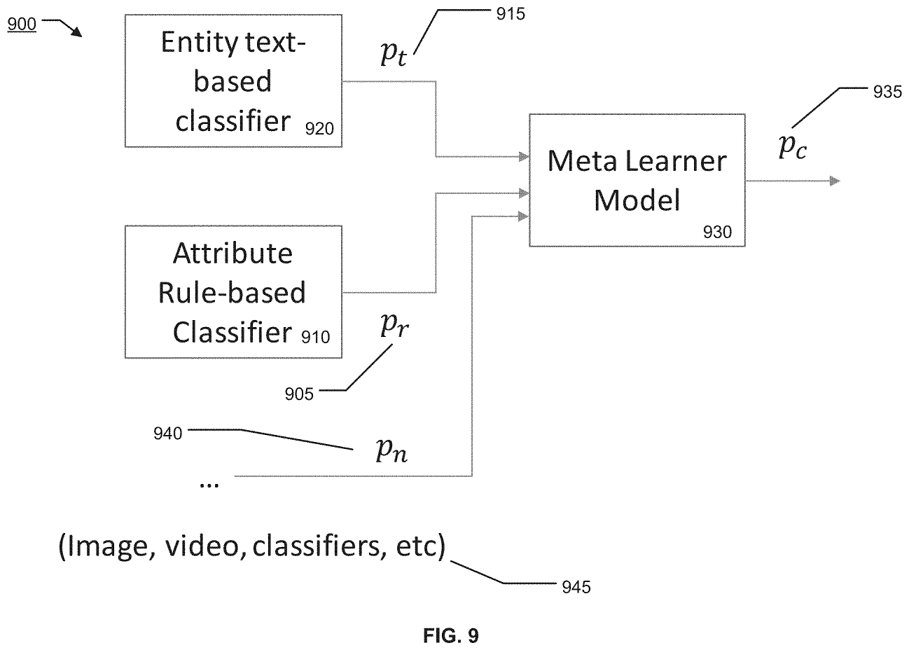

At step 530, the meta learner model 455 may apply weights or utilize a neural network model to combine the outputs of the attribute rule-based classifier 445 and the text-based classifier 460. FIG. 9 illustrates an exemplary embodiment of a meta learner model 930 as part of a system 900 for adding a new attribute to an existing knowledge base. In system 900, pᵣ 905 may be defined as the confidence measure output by the attribute rule-based classifier 910 for attribute presence, and pₜ 915 may be defined as the prediction probability output by the text-based classifier 920. The meta learner model 930 may output a combined prediction probability p_{c} 935 that combines the prediction probability outputs of the rule-based classifier 910 and the text-based classifier 920 to identify association of unlabeled entities with presence or absence of the new attribute. Thresholds can then be applied on the prediction probability 935 to detect attribute presence (e.g., when prediction probability 935>predetermined threshold 1), attribute absence (e.g., when prediction probability 935<predetermined threshold 2), or provide an unsure output when neither threshold is satisfied. Threshold 1 and threshold 2 may be learned by the meta learner model 930 to maximize test accuracy on the held-out testing set. One technique to compute p_{c} may be to set p_{c}=wᵣpᵣ+wₜpₜ, where parameter weights wᵣ and wₜ may be learned from training data using any suitable supervised learning techniques. In another embodiment, as shown in FIG. 9, supervised learning algorithms such as logistic regression or a neural network may be used for meta learner model 930 to compute p_{c} 935 (the attribute detection probability) based on prediction probabilities output from the rule-based classifier 910, text-based classifiers 920, and other classifiers 945 operating on unstructured data (resulting in prediction probabilities pₙ 940). For each entity, the supervised learning algorithm used by meta learner model 930 may receive as input the prediction probabilities of individual classifiers, along with the ground truth attribute presence or absence from the training data.

Returning again to FIG. 5, the seeding the training data in block 505 may include receiving labeled training data candidates from candidate users selected based on past behavior in some embodiments (not shown in FIG. 5). Furthermore, the seeding may also include additional candidate training data 540 in some embodiments. This additional candidate training data 540 may be generated by selecting additional candidate entity training examples based on attribute prediction uncertainty and a number of similar entities to the selected additional candidate entity examples at step 535. FIG. 6 shows a specific embodiment of a flow diagram for a method 600 of generating training data for the various models used in adding a new attribute to an existing knowledge base. Given a new attribute a, method 600 generates labeled example entities indicating the presence or absence of the attribute a. The training data may include a set of entity-attribute pairs, which include positive examples such as (e1, a) for some entity e1 and negative examples (e2, !a) for some other entity e2. In an exemplary embodiment, crowd-sourcing may be used to generate an initial set of positive and negative training seed examples at step 605. From the seed examples, an initial attribute classifier, such as an association rule-based attribute classifier, may be created.

Based on an information density-sensitive active learning approach, additional candidate positive & negative examples are selected at step 610 based on a utility score. Unlike an active learning approach, which only takes the uncertainty-based utility of a new training example into account, an information density-sensitive active learning approach takes into account both the uncertainty-based utility and the density (number of similar examples in the knowledge base) of a candidate example when deciding on the overall utility of the candidate example. An exemplary embodiment of an information density-sensitive active learning approach is described in further detail below. The utility score may combine a traditional uncertainty-based utility score and also an entity similarity measure between the candidate entity and other entities. In an exemplary embodiment, the combined utility score Uₙ(x) may be expressed as follows:

Uₙ(x)=U(x)KNN(x).

As stated above, the utility score Uₙ(x) of an entity-attribute pair x may be based on the uncertainty-based utility score for the entity-attribute pair U(x) and the similarity measure KNN(x). The uncertainty-based utility score U(x) for unlabeled entities may be specific to the attribute classifier created from the seed examples. For an exemplary attribute-rule based classifier embodiment, entities that have the least confidence value for the most likely prediction (attribute presence or absence) may be rated as having higher utility. Therefore, U(x) may defined in one embodiment as:

U(x)=(1−confidence(x)),

where confidence (x) is the confidence of the attribute rule corresponding to the most likely prediction of the rule-based classifier (attribute presence or absence), expressed as a number between 0 and 1. In other embodiments, both the confidence and the support or lift factor of the highest confidence attribute rule may also be used to determine the uncertainty-based utility score.

In addition to the utility score, the association-rule classifier may also determine the utility score based on how many similar entities to a candidate entity are present in the knowledge graph using KNN(x) as shown above. In one example embodiment, KNN(x) may be defined as follows:

KNN(x)=Σᵢ₌₁ⁿ cosine_similarity(E(x),E(xᵢ),

Where xᵢ (for i=1 to n) are the n closest entities to candidate x in the embedding space as defined by E. Embedding approaches may be used to map each entity x in the knowledge graph to a vector E(x), which allows vector-based comparisons of different entities. Any suitable KG or graph embedding approach, such as node2vec or transE, for example, can be used for the embedding transformation (as is shown by block 420 in FIG. 4). As shown above, entity similarity may be computed by applying cosine similarity on KG entity embeddings of the n closest embeddings. This may be done so that the selected entities used as training data may be selected to reduce the number of training examples and avoid outliers. For example, for some target movie A, if a large number of movies satisfy rule (plotElement=junkie)->‘drug-use,’ the average entity similarity score to other movies in the KG may be higher, which favors selecting movie A for labeling as having the new attribute.

Given a set of candidate positive and negative entity examples, for each example, users who have labeled the entity in the past, or labeled similar entities or attributes in the past, may be selected at step 615. By doing so, optimal users may be selected to label the entities used as training data during the training phase of the new attribute model. In some embodiments, a user who wishes to add the new attribute may act as the optimal user. For example, the user may be prompted, in response to receiving a new attribute to be added, to label example entities, which may then be used to train the rule-based model and the unstructured data model, thereby avoiding a need for crow-sourced data.

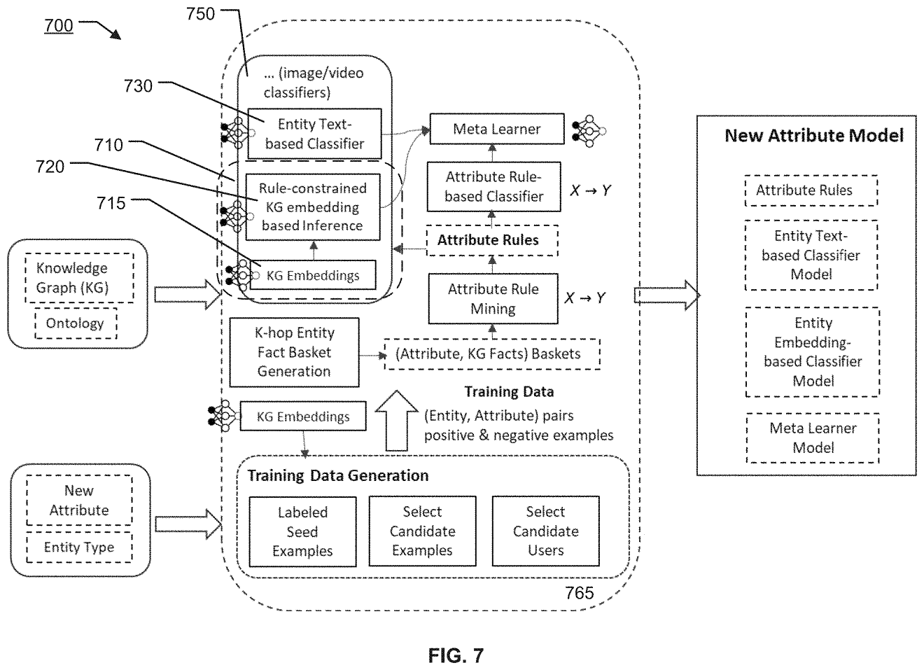

To potentially improve accuracy further, the identified association rules can be used with the KG embeddings to infer the presence or absence of attributes. FIG. 7 shows a block diagram of a specific embodiment of a system 700 for adding a new attribute to an existing knowledge base that incorporates an additional model 710 for entity embedding-based attribute inference. Using an Integer Linear Programming (ILP) formulation, mined attribute rules 440 can be expressed as constraints on the Boolean decision variables xᵢⱼ^{(k)} for candidate entity facts (e.g., a movie has existing attribute A). Below, we show the formulation for a simple relation association rules of the form r₁->r₂:

wᵢⱼ^{(k)}=f(eᵢ,rₖ,eⱼ)

(expressing the plausibility of the rule predicted by transE embedding)

$${max}_{\{ {x}_{ij}^{( k )} , {ϵ}_{ij}^{( k )} \}} {\sum }_{k} {\sum }_{i} {\sum }_{j} {w}_{ij}^{( k )} {x}_{ij}^{( k )}$$

(ILP formulation)
xᵢⱼ^{(k}^{₁}⁾≤xᵢⱼ^{(k}^{₂}⁾, ∀rₖ_{₁} [symbol] , ∀i, •j,
(displaying a constraint on embeddings introduced by sample mined rules)
where xᵢⱼ^{(k)}∈{0, 1}, ∀k, i, j; ϵᵢⱼ^{(k)}∈{0, 1}, ∀t⁺∈ [symbol] .

The constraint on embeddings may be applied to the set of all embeddings, generated using a separate embedding model 715 for the entities of the knowledge base. The model 715 operates by converting each existing attribute of the plurality of entities into a vector representation. The constraint then filters the vectors to identify only embeddings that are similar to the training entities that satisfy the mined rules. The output of the embedding-based attribute inference 720 can be another input to the meta learner model, which applies a weight to the rule-constrained KG embedding-based inferences and outputs attribute presence/absence, as described above.

While the examples described above pertain to a movie knowledge base, the systems and methods described above may be applied to any suitable knowledge base to add new attributes. For example, in a recipe knowledge base, attributes such as gluten-free, spicy, meaty, etc. may be added to recipe entities in an existing knowledge base. Similarly, the systems and methods described herein may be used to add attributes such as dry, acidic, fruity, etc. to a knowledge base to wines, where a user may scan a wine bottle and query whether or not the wine has such attributes. There is no restriction to the type of knowledge bases or entities to which the above-described systems or methods may be applied.

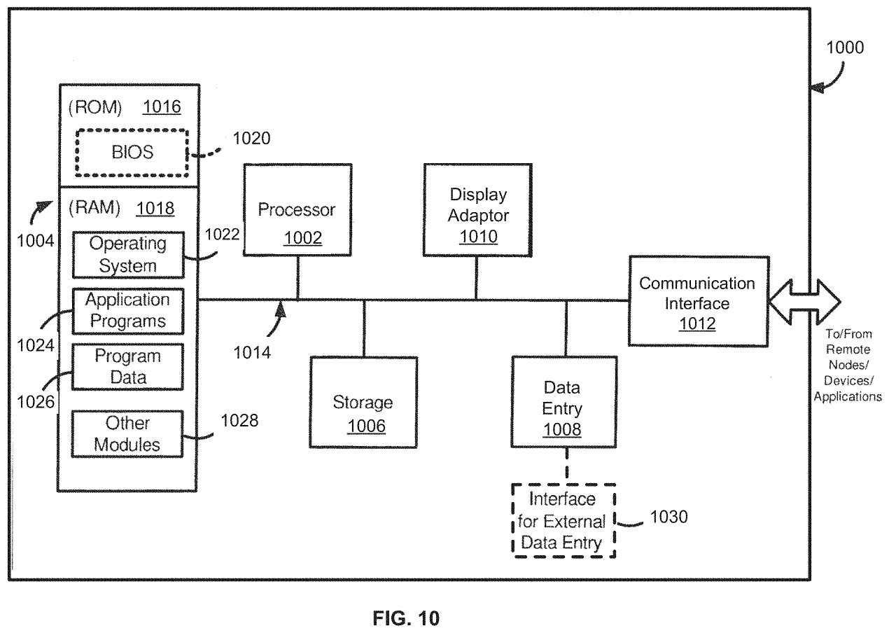

FIG. 10 is a block diagram of an exemplary system used to automatically determine sentiment with regard to communications in the technical support context (such as customer device 110, agent device 104, or any devices used to implement system 100). With reference to FIG. 10, an exemplary system for implementing the subject matter disclosed herein, including the methods described above, includes a hardware device 1000, including a processing unit 1002, memory 1004, storage 1006, data entry module 1008, display adapter 1010, communication interface 1012, and a bus 1014 that couples elements 1004-1012 to the processing unit 1002.

The bus 1014 may comprise any type of bus architecture. Examples include a memory bus, a peripheral bus, a local bus, etc. The processing unit 1002 is an instruction execution machine, apparatus, or device and may comprise a microprocessor, a digital signal processor, a graphics processing unit, an application specific integrated circuit (ASIC), a field programmable gate array (FPGA), etc. The processing unit 1002 may be configured to execute program instructions stored in memory 1004 and/or storage 1006 and/or received via data entry module 1008.

The memory 1004 may include read only memory (ROM) 1016 and random access memory (RAM) 1018. Memory 1004 may be configured to store program instructions and data during operation of device 1000. In various embodiments, memory 1004 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 1004 may also include nonvolatile memory technologies such as nonvolatile flash RAM (NVRAM) or ROM. In some embodiments, it is contemplated that memory 1004 may include a combination of technologies such as the foregoing, as well as other technologies not specifically mentioned. When the subject matter is implemented in a computer system, a basic input/output system (BIOS) 1020, containing the basic routines that help to transfer information between elements within the computer system, such as during start-up, is stored in ROM 1016.

The storage 1006 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 1000.

It is noted that the methods described herein can be embodied in executable instructions stored in a non-transitory computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment.

As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 1006, ROM 1016 or RAM 1018, including an operating system 1022, one or more applications programs 1024, program data 1026, and other program modules 1028. A user may enter commands and information into the hardware device 1000 through data entry module 1008. Data entry module 1008 may include mechanisms such as a keyboard, a touch screen, a pointing device, etc. Other external input devices (not shown) are connected to the hardware device 1000 via external data entry interface 1030. By way of example and not limitation, external input devices may include a microphone, joystick, game pad, satellite dish, scanner, or the like. In some embodiments, external input devices may include video or audio input devices such as a video camera, a still camera, etc. Data entry module 1008 may be configured to receive input from one or more users of device 1000 and to deliver such input to processing unit 1002 and/or memory 1004 via bus 1014.

The hardware device 1000 may operate in a networked environment using logical connections to one or more remote nodes (not shown) via communication interface 1012. The remote node may be another computer, a server, a router, a peer device or other common network node, and typically includes many or all of the elements described above relative to the hardware device 1000. The communication interface 1012 may interface with a wireless network and/or a wired network. Examples of wireless networks include, for example, a BLUETOOTH network, a wireless personal area network, a wireless 802.12 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 1012 may include logic configured to support direct memory access (DMA) transfers between memory 1004 and other devices.

In a networked environment, program modules depicted relative to the hardware device 1000, or portions thereof, may be stored in a remote storage device, such as, for example, on a server. It will be appreciated that other hardware and/or software to establish a communications link between the hardware device 1000 and other devices may be used.

It should be understood that the arrangement of hardware device 1000 illustrated in FIG. 10 is but one possible implementation and that other arrangements are possible. It should also be understood that the various system components (and means) defined by the claims, described above, and illustrated in the various block diagrams represent logical components that are configured to perform the functionality described herein. For example, one or more of these system components (and means) can be realized, in whole or in part, by at least some of the components illustrated in the arrangement of hardware device 1000.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 10.

Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

The subject matter has been described herein with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

For purposes of the present description, the terms “component,” “module,” and “process,” may be used interchangeably to refer to a processing unit that performs a particular function and that may be implemented through computer program code (software), digital or analog circuitry, computer firmware, or any combination thereof.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

In the description herein, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of a preferred embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure.

What is claimed is:

1. A method comprising:
retrieving, at an electronic device, a new attribute;
mining, at the electronic device, attribute rules determining relationships between existing attributes of a first plurality of entities from a knowledge base (KB) and the new attribute, wherein each attribute rule is associated with a confidence value;
training a rule-based classifier by applying the attribute rules to a second plurality of entities, wherein the rule-based classifier controls application of an attribute rule based on a confidence value threshold; and
training a meta learner by applying a weight to an output of the rule-based classifier, wherein the meta learner identifies association of entities of the KB with the new attributes.

2. The method of claim 1, further comprising identifying, using an unstructured data model, unstructured data associated with each entity of the second plurality of entities that is correlated to presence of the new attribute, the training the meta learner further comprising applying weights for the identified unstructured data based on prediction probabilities associated with the identified unstructured data and identifying association of entities of the KB with the new attributes based on the weighted output of the rule-based classifier and the weighted identified unstructured data associated with each entity of the second plurality of entities.

3. The method of claim 2, the identifying unstructured data being based on positive and negative entity-attribute training data, the training data being augmented by entity-attribute data generated by the rule-based model, the generated entity-attribute data from the rule-based model having confidence values exceeding a predetermined threshold.

4. The method of claim 1, the identifying correlations between the new attribute and existing attributes being based on selected positive and negative entity-attribute training data, the selecting comprising:
receiving a plurality of entity-attribute pairs provided by users, the entity-attribute pairs comprising an entity of the plurality of entities and a label of either positive or negative presence of the new attribute;
determining a utility of each entity-attribute pair based on entity similarity and uncertainty values determined for each pair; and
selecting a subset of the plurality of entity-attribute pairs base based on having a utility greater than a predetermined threshold.

5. The method of claim 4, the identifying correlations between the new attribute and existing attributes further comprising using the selected subset of the plurality of entity-attribute pairs to generate entity fact baskets for each of the selected subset, the fact baskets each comprising all of the attributes of a corresponding entity-attribute pair, the associating an attribute rule further comprising identifying individual existing attributes and combinations of existing attributes within the subset of entity-attribute pairs having confidence values greater than the predetermined threshold as rules.

6. The method of claim 1, the plurality of attribute rules comprising positive rules, indicating presence of the new attribute, and negative rules, indicating absence of the new attribute.

7. The method of claim 1, the identifying correlations between the new attribute and existing attributes being based on selected positive and negative entity-attribute training data, wherein the identifying the unstructured data comprises:
receiving a plurality of entity-attribute pairs provided by users, the entity-attribute pairs comprising an entity of the plurality of entities and either positive or negative presence of the new attribute, each entity of the entity-attribute pairs being further associated with unstructured data; and
based on the unstructured data of the entity-attribute pairs, identifying correlations between features of the unstructured data of the entity-attribute pairs and both presence and absence of the new attribute, the identified unstructured data comprising unstructured data of the entity-attribute pairs having a prediction probability exceeding a second predetermined threshold.

8. The method of claim 7, the identifying the unstructured data further comprising receiving additional entity-attribute pairs from the rule-based model, the additional entity-attribute pairs comprising entities identified using the plurality of attribute rules as having the new attribute, and identifying additional correlations between features of unstructured data associated with each of the additional entity-attribute pairs, the identified unstructured data further comprising unstructured data of the additional entity-attribute pairs having a prediction probability exceeding the second predetermined threshold.

9. The method of claim 1, wherein the identified unstructured data is interpreted as a virtual rule by the meta learner model such that the weights for each attribute rule and each virtual rule are applied based on the confidences associated with each attribute rule and each associated identified unstructured data.

10. The method of claim 1, further comprising:
expressing the plurality of attribute rules as constraints on Boolean decision variables for entity existing attributes;
identifying embeddings for entities identified using the plurality of attribute rules.

11. A computer program product comprising computer-readable program code to be executed by one or more processors when retrieved from a non-transitory computer-readable medium, the program code including instructions to:
retrieve a new attribute;
mine attribute rules determining relationships between existing attributes of a first plurality of entities from a knowledge base (KB) and the new attribute, wherein each attribute rule is associated with a confidence value;
training a rule-based classifier by applying the attribute rules to a second plurality of entities, wherein the rule-based classifier controls application of an attribute rule based on a confidence value threshold; and
train a meta learner by applying a weight to an output of the rule-based classifier, wherein the meta learner identifies association of entities of the KB with the new attributes.

12. The computer program product of claim 11, further comprising instructions to identify, using an unstructured data model, unstructured data associated with each entity of the second plurality of entities that is correlated to presence of the new attribute, the training the meta learner further comprising applying weights for the identified unstructured data based on prediction probabilities associated with the identified unstructured data and identifying association of entities of the KB with the new attributes based on the weighted output of the rule-based classifier and the weighted identified unstructured data associated with each entity of the second plurality of entities.

13. The computer program product of claim 12, the identifying unstructured data being based on positive and negative entity-attribute training data, the training data being augmented by entity-attribute data generated by the rule-based model, the generated entity-attribute data from the rule-based model having confidence values exceeding a predetermined threshold.

14. The computer program product of claim 11, the identifying correlations between the new attribute and existing attributes being based on selected positive and negative entity-attribute training data, the selecting comprising:
receiving a plurality of entity-attribute pairs provided by users, the entity-attribute pairs comprising an entity of the plurality of entities and a label of either positive or negative presence of the new attribute;
determining a utility of each entity-attribute pair based on entity similarity and uncertainty values determined for each pair; and
selecting a subset of the plurality of entity-attribute pairs base based on having a utility greater than a predetermined threshold.

15. The computer program product of claim 14, the identifying correlations between the new attribute and existing attributes further comprising using the selected subset of the plurality of entity-attribute pairs to generate entity fact baskets for each of the selected subset, the fact baskets each comprising all of the attributes of a corresponding entity-attribute pair, the associating an attribute rule further comprising identifying individual existing attributes and combinations of existing attributes within the subset of entity-attribute pairs having confidence values greater than the predetermined threshold as rules.

16. The computer program product of claim 11, the plurality of attribute rules comprising positive rules, indicating presence of the new attribute, and negative rules, indicating absence of the new attribute.

17. The computer program product of claim 11, the identifying correlations between the new attribute and existing attributes being based on selected positive and negative entity-attribute training data, wherein the identifying the unstructured data comprises:
receiving a plurality of entity-attribute pairs provided by users, the entity-attribute pairs comprising an entity of the plurality of entities and either positive or negative presence of the new attribute, each entity of the entity-attribute pairs being further associated with unstructured data; and
based on the unstructured data of the entity-attribute pairs, identifying correlations between features of the unstructured data of the entity-attribute pairs and both presence and absence of the new attribute, the identified unstructured data comprising unstructured data of the entity-attribute pairs having a prediction probability exceeding a second predetermined threshold.

18. The computer program product of claim 17, the identifying the unstructured data further comprising receiving additional entity-attribute pairs from the rule-based model, the additional entity-attribute pairs comprising entities identified using the plurality of attribute rules as having the new attribute, and identifying additional correlations between features of unstructured data associated with each of the additional entity-attribute pairs, the identified unstructured data further comprising unstructured data of the additional entity-attribute pairs having a prediction probability exceeding the second predetermined threshold.

19. The computer program product of claim 11, wherein the identified unstructured data is interpreted as a virtual rule by the meta learner model such that the weights for each attribute rule and each virtual rule are applied based on the confidences associated with each attribute rule and each associated identified unstructured data.

20. The computer program product of claim 11, further comprising instructions to:
express the plurality of attribute rules as constraints on Boolean decision variables for entity existing attributes; and
identify embeddings for entities identified using the plurality of attribute rules.
